(19) United States
(12) Patent Application Publication
(10) Pub. No.: US 2019/0184487 A1
(43) Pub. Date: Jun. 20, 2019

(54) WELDING ELECTRODE CAP

(71) Applicant: Bryan Prucher, Clarkston, MI (US)

(72) Inventor: Bryan Prucher, Clarkston, MI (US)

(21) Appl. No.: 16/197,499

(22) Filed: Nov. 21, 2018

Related U.S. Application Data
(63) Continuation-in-part of application No. 15/568,012, filed on Oct. 20, 2017.

(51) Int. Cl. B23K 11/30; B23K 35/02; B23K 35/22; B23K 35/32

(52) U.S. Cl. CPC B23K 11/3018; B23K 35/0261; B23K 35/32; B23K 35/222; B23K 35/0205

(57) ABSTRACT

A domed copper electrode tip has a refractory insert inserted thereinto extending from the apogee of the dome into the interior of the electrode. The refractory insert is, preferably, a tungsten insert which is force-fitted into the interior of the electrode tip.

### CROSS-REFERENCE TO RELATED APPLICATION

This application is a continuation-in-part of Application, Ser. No. 15/568,012, filed Oct. 20, 2017 for “IMPROVED WELDING ELECTRODE CAP”, the disclosure which is hereby incorporated by reference, including the drawing.

### BACKGROUND OF THE INVENTION

### 1. Field of Invention

This invention relates, in general, to resistance spot welding equipment and, more specifically, to resistance spot welding electrodes. More particularly, the present invention concerns replaceable resistance spot welding electrode caps. Even more particularly, the present invention concerns means and methods for improving the thermal heat dissipation properties of such welding electrode caps.

### 2. Description of Related Art

In the above referred to co-pending application there is disclosed an improved electrode tip which provides greater cooling surface for the interior fins thereof by having chamfered ends.

The chamfered ends are intended to provide greater surface area for the liquid coolant which is introduced into the interior in association with such finned electrodes.

However, one of the deficiencies which is continuously encountered with such electrode tips is their useful life. Because of the heat generated during the robotic welding process the life of these tips, even in spite of the coolant being introduced into the interior thereof, still is not satisfactory.

Thus, there exists a need in the art for improving the useful life of these electrode tips. It is to this to which the present invention is directed.

### SUMMARY OF THE INVENTION

In accordance with the present invention there is provided an electrode tip having an improved useful life and which, generally, comprises: a domed copper-based electrode tip having a refractory material insert disposed centrally and medially of the tip at the apogee thereof.

Since the refractory material has a melting point far in excess of that of the electrode tip the insert serves to increase the useful life thereof. The refractory insert is installed at the apogee of the dome by force-fitting thereinto.

In order to effectuate the insert a small opening is formed at the tip of the dome. Thereafter, the refracting material is forced therethrough until it is disposed fully in the interior of the electrode tip with its outer surface being co-planar and circumferentially integrated into the exterior of the tip.

For a more complete understanding of the present invention reference is made to the following detailed description and accompany drawing.

In the drawing like reference characters refer to like parts throughout the several views, in which:

### BRIEF DESCRIPTION OF THE DRAWINGS

FIGS. 1A-1C illustrate, in cross-section, the insertion of a refractory insert into a standard electrode tip in accordance with the present invention; and

FIG. 2A-2C illustrate, in cross-section, the insertion of a refractory insert into a finned electrode.

### DETAILED DESCRIPTION OF THE PREFERRED EMBODIMENT

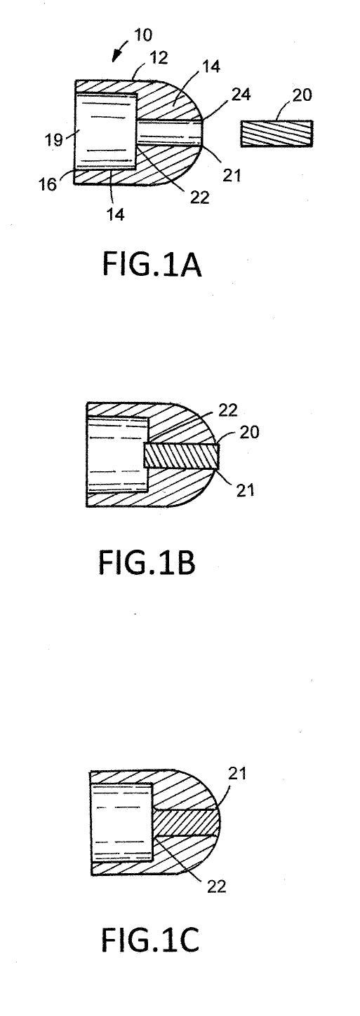

Now, and with reference to the drawing and, in particular, FIG. 1, there is depicted therein an electrode tip 10. The tip 10 is of the type comprising a substantially cylindrical sidewall 12 with a dome tip 14 integrally formed therewith. The tip has a hollow interior 15 having an entry 16 for receiving an electrode shank 19.

As is known to the skilled artisan a robotic electrode tip 10 is typically formed from copper or a dispersion strengthened copper alloy. Such materials are well known to the skilled artisan.

Further, as is known to the skilled artisan such copper or copper-based electrode tips have a melting point of about 1100° F. Under ordinary conditions robotic welding will typically take place at the melting temperature of steel, i.e. about 2750° F. Because of high temperatures at which welding occurs such electrode tips, generally, have a useful life of about 2500 to about 3600 welds.

In accordance herewith and as shown in the drawing a medial or central refractory insert 20 is inserted into the interior 15 of the tip and has a length extending from the apogee 21 of the tip of the electrode shank to the interior terminus 22 of the dome 14 of the tip 10 and is imparted with a curvature or other shape such that it is contiguous with the dome of the tip such that there are no discontinuities associated therewith.

The refractory material may be of any type which has a melting point in excess of that of the copper or copper alloy.

Preferably, among the useful refractory materials are, for example, molybdenum, rhenium, niobium, tungsten, tantalum and the like. The preferred refractory material is tungsten which has a melting point of approximately 6200° F.

The tungsten insert can be manufactured by any suitable well known method including powder metallurgical processing.

Referring again to the drawing, the refractory insert 20 is inserted into the tip 14 by initially providing a small opening 24 in the dome by any suitable means such as by a punch or the like as well as by drilling in a secondary operation. The insert is, then, force-fitted into the interior of the tip until it reaches with the interior terminus of the electrode top.

Any discontinuities are avoided through the force-fitting by having the tungsten insert by being of a diameter slightly larger than that of the pierced or drilled opening into which it is inserted.

The insert can be force-fitted through any suitable means including manually with a hammer or through any automatic press or the like.

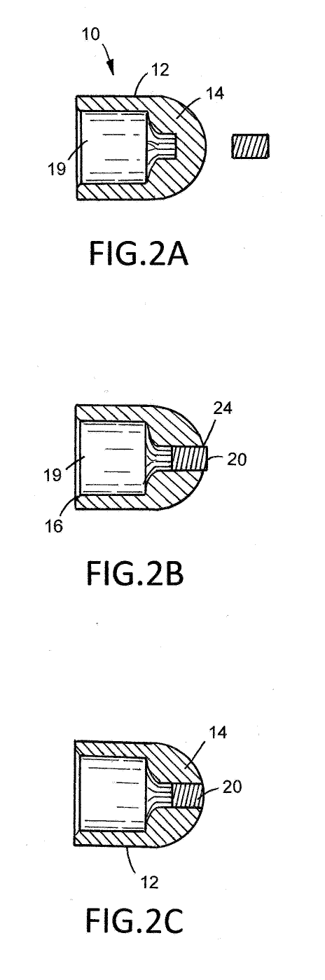

It is to be appreciated herein that the present invention is applicable to any type of copper-based electrode tip be it internally finned such as shown in FIGS. 2A-2C or the standard, non-finned electrode of FIGS. 1A-1C.

Having thus described the invention, what is claimed is:

### INDEX OF REFERENCE NUMERALS

Electrode tip 10

Sidewall 12

Dome 14

Interior 15

Entry 16

Electrode
Shank 19

Insert 20

Apogee 21

Dome Interior
Terminus 22

Opening 24

1. In a copper-based electrode tip of the type having a domed top, the improvement which comprises:
a refractory material insert extending from the apogee of the dome into the interior of the electrode tip.

2. The improvement of claim 1 wherein the refractory material is selected from the group consisting of molybdenum, rhenium, niobium, tantalum and tungsten

3. The improvement of claim 2 wherein the refractory material is tungsten.

4. The improvement of claim 1 wherein the electrode tip is an interiorly finned electrode.

5. The improvement of claim 1 wherein the electrode tip is a copper tip.

6. The improvement of claim 1 wherein the electrode tip is a dispersion strengthened copper tip.

7. A method for manufacturing an electrode tip comprising:
piercing an opening into the electrode tip and force-fitting a refractory insert from the exterior surface of the tip of the electrode into the interior thereof.
